(19) United States
(12) Patent Application Publication
(10) Pub. No.: US 2004/0249098 A1
(43) Pub. Date: Dec. 9, 2004

(54) (Meth)acrylic and (meth)acrylamide monomers comprising cyclic acetal/thioacetal groups, polymerizable compositions, and polymers obtained

(75) Inventors: Christopher N. Bowman, Boulder, CO (US); Kathryn A. Berchtold, Los Alamos, NM (US)

Correspondence Address: QUINE INTELLECTUAL PROPERTY LAW GROUP, P.C., P O BOX 458, ALAMEDA, CA, 94501, US

(73) Assignee: The Regents of the University of Colorado, Boulder, CO

(21) Appl. No.: 10/783,990

(22) Filed: Feb. 20, 2004

Related U.S. Application Data
(60) Provisional application No. 60/449,773, filed on Feb. 24, 2003.

(51) Int. Cl. C08F 118/02

(52) U.S. Cl. 526/319

(57) ABSTRACT

The present invention provides novel (meth)acrylic and (meth)acrylamide monomers and polymers produced from those monomers. The monomers of the invention each include only a single vinyl functionality and at least one non-vinyl functionality that can be varied to achieve desired monomer/polymer properties. The invention additionally provides methods of producing polymers from these mono-vinyl monomers.

### CROSS-REFERENCES TO RELATED APPLICATIONS

This application claims the benefit of U.S. Provisional Application No. 60/449,773, filed Feb. 24, 2003, the disclosure of which is incorporated by reference in its entirety for all purposes.

### STATEMENT AS TO RIGHTS TO INVENTIONS MADE UNDER FEDERALLY SPONSORED RESEARCH AND DEVELOPMENT

This invention was made with government support under Grant Nos. DE10959 and EEC-0002971 awarded by the U.S. Department of Health and Human Services and the National Science Foundation, respectively. The government has certain rights in the invention.

### COPYRIGHT NOTIFICATION

Pursuant to 37 C.F.R. § 1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### BACKGROUND OF THE INVENTION

The photopolymerization or radiation-based curing of light sensitive materials is a multibillion dollar business. The photopolymer products of these processes are typically derived from polymers, oligomers, and/or monomers that can be selectively polymerized and/or crosslinked upon imagewise exposure to various types of electromagnetic radiation, including ultra-violet light, visible light, and electron beam radiation. Significant advantages that photopolymerizable systems have over other polymerization techniques, such as traditional thermal processing methods, include low energy requirements, spatial and temporal control of initiation, solvent-free formulations, and high polymerization rates at room temperature. They also provide tremendous chemical versatility in view of the wide range of monomers that can be photochemically polymerized.

Due to this unique set of advantages, photopolymerization systems have gained prominence for the solvent-free curing of polymer films as well as emerging applications in biomedical materials, conformal coatings, electronic and optical materials, and rapid prototyping of three dimensional objects. More specifically, photopolymers are made into different forms including films, sheets, liquids, and solutions, which are utilized in, e.g., printing plates, photoresists, stereolithography, and imaging. To further illustrate, photoresists are used to fabricate integrated circuits, flat panel displays, printed circuits, screen printing products, chemically milled parts, and micro- and nano-electromechanical systems (MEMS/NEMS). Liquid compositions can also be used for non-imaging applications such as adhesives, coatings, paints, inks, and related photosensitive products. Photopolymerizations also have in vivo applications in, e.g., open environments such as the oral cavity in addition to uses in invasive and minimally invasive surgery. In vivo photopolymerizations have even been performed transdermally.

Photopolymerization systems, processes, and related applications of radiation cured polymers are further described in a variety of general reference sources. Certain of these include, e.g., Lowe et al., Test Methods for UV and EB Curable Systems, Wiley —SITA Technology (1997), Drobny, Radiation Technology for Polymers, CRC Press (2002), Datta, Rubber Curing Systems (Rapra Review Report 144), Rapra (2002), Provder et al. (Eds.), Film Formation in Coatings: Mechanisms, Properties, and Morphology (ACS Symposium Series 790), American Chemical Society (2001), Mehnert et al., Chemistry & Technology of UV & EB Formulation for Coatings, Inks & Paints, Vol. 1: UV & EB Curing Technology & Equipment, Wiley—SITA Technology (1999), Neckers et al., Chemistry & Technology of UV & EB Formulation for Coatings, Inks & Paints, Vol. 7: Photoinitiation for Polymerization: UV & EB at the Millenium, Wiley—SITA Technology (1999), Satas et al. (Eds.), Coatings Technology Handbook, 2nd Ed., Marcel Dekker (2001), Bradley (Ed.), Chemistry & Technology of UV & EB Formulation, Vol. 3: Photoinitators for Free Radical Cationic & Anionic Photopolymerisation, 2nd Ed., Wiley—SITA Technology (1998), Warson et al., Applications of Synthetic Resin Latices, Vol. 1: Fundamental Chemistry of Latices and Applications in Adhesives, John Wiley & Sons (2001), Davidson, Radiation Curing (Rapra Review Report 136), Rapra (2001), and Fouassier, Photoinitiated Polymerisation: Theory and Applications (Rapra Review Report 100), Rapra (1997).

The quality and performance of polymers are linked to the cure characteristics of the polymerization system. Monomers that include multiple vinyl functionalities are an industry standard in many common photopolymerization schemes. Many of these multi-vinyl monomer-based polymerizations suffer from significant limitations. To illustrate, multi-vinyl monomers typically react to far less than quantitative double bond conversion. This generally results in polymeric materials having relatively high residual/leachable monomer content. Accordingly, these materials are often toxic and have limited durability. In addition to incomplete reactions, multi-vinyl monomer-based polymerizations are typically slow, requiring lengthy exposure times at high radiation intensities. These aspects increase production costs and generally have negative environmental implications.

In view of the foregoing discussion, it is apparent that there is a substantial need for monomers that have higher polymerization rates and that polymerize more completely than conventional monomers with multiple vinyl functionalities. For example, improvements in monomer curing efficiency would allow optimum polymer properties to be achieved with minimized irradiation times and intensities. These and a variety of other features of the present invention will become apparent upon complete review of the following disclosure.

### SUMMARY OF THE INVENTION

The present invention generally relates to polymer chemistry. More specifically, the invention provides novel (meth)acrylic and (meth)acrylamide monomers that each include only a single vinyl polymerizable moiety or functionality. The monomers disclosed herein generally have high polymerization reactivities that in many cases exceed the rates of reaction typically achieved in homopolymerizations involving monomers having multiple vinyl functionalities. Accordingly, the present invention also provides polymerizable compositions that typically include selected combinations of the novel (meth)acrylic and (meth)acrylamide monomers disclosed herein. Optionally, a polymerizable composition of the invention includes at least one of the novel monomers disclosed herein in addition to other monomers, such as those comprising multiple vinyl functionalities. Further, the invention additionally relates to the polymers produced from these novel monomers and to the unique material properties or characteristics of these polymers, which properties are typically readily tailored to suit varied specifications.

In one aspect, the invention provides a monomer corresponding to a compound of formula (I):

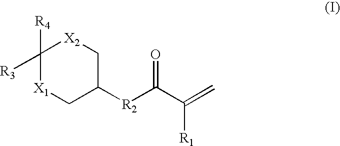

in which R₁ is CH₃ or H and R₂ is (R₂ₐ)ₘWₙ(R_{2b})ₚY_{q}Z. R₂ₐ and R_{2b} are independently selected from carbonates, carbamates, ureas, dithiocarbonates, dithiocarbamates, thiocarbonates, thioureas, trithiocarbonates, and thiocarbamates, and m and p are independently selected from 0 and 1. Further, W is selected from CH₂ and (CH₂)ₜO, Y is selected from CH₂ and (CH₂)ₙO, t and s are integers independently selected from 0 to 50 inclusive, n and q are integers independently selected from 0 to 50 inclusive, and Z is O or NH and is attached to the carbonyl moiety. In addition, R₃ and R₄ are independently selected from H, a substituted or unsubstituted alkyl group, and a substituted or unsubstituted aromatic group, and X₁ and X₂ are independently selected from O and S. Moreover, (a) if Z is O, Y is CH₂, q is an integer from 1 to 4 inclusive, and m, n, and p are 0, then at least one of X₁ and X₂ is S; (b) if Z is 0, W is CH₂, n is an integer from 1 to 4 inclusive, and m, p, and q are 0, then at least one of X₁ and X₂ is S; and, (c) if Z is 0 and m, n, p, and q are 0, then at least one of X₁ and X₂ is S. In certain embodiments, the alkyl group or the aromatic group of R₃ or R₄ includes at least one ring optionally having 3, 4, 5, 6, 7, 8, or more members. In preferred embodiments, the monomer is selected from Table I.

In other aspects, the invention provides a polymerizable composition that includes at least two monomers in which at least one of the monomers corresponds to the compound of formula (I) described above. The polymerizable composition, which is typically in the liquid state, optionally further includes at least one diluent, at least one initiator, at least one additive, and/or the like. The invention also provides a polymer comprising at least one monomeric unit derived from the compound of formula (I) described above. In addition, the invention also relates to an article comprising the polymers described herein. For example, the article optionally includes at least one coating that comprises a polymer described herein. To further illustrate, the article is optionally selected from, e.g., a dental restorative material, a lithographic material, a membrane, an adhesive, a printing plate, an ink, a holographic material, a biomaterial, and the like.

In an additional aspect, the invention provides a method of producing a polymer. The method includes reacting at least two monomers with one another in which at least one of the monomers corresponds to a compound of formula (I), as described above. The reacting step includes one or more of, e.g., irradiating a composition comprising the monomers, heating a composition comprising the monomers, adding at least one catalyst to a composition comprising the monomers, etc. In some embodiments, a composition that includes the monomers further comprises at least one initiator and/or other composition components. The monomers typically react with one another to substantially quantitative double bond conversion.

### BRIEF DESCRIPTION OF THE DRAWINGS

FIG. 1 is a data graph (abscissa—polymerization time (seconds); ordinate—conversion) that shows the effect of 5 and 6 membered ring composition on cyclic acetal polymerization at 25° C.

FIG. 2 is a data graph (abscissa—polymerization time (seconds); ordinate—conversion) that illustrates a comparison of a 6 membered acetal acrylate to a divinyl HDDA polymerization.

FIG. 3 is a data graph (abscissa—polymerization time (seconds); ordinate—conversion) that shows a comparison of a cyclic acetal OCN acrylate with a 6 membered acetal acrylate and a divinyl HDDA polymerizations.

FIGS. 4 is a data graph (abscissa—polymerization time (seconds); ordinate—conversion) that illustrates the effect of temperature on a cyclic acetal OCN acrylate polymerization.

FIG. 5 is a data graph (abscissa—polymerization time (seconds); ordinate—conversion) that shows the effect of temperature on initiatorless polymerizations.

### DETAILED DISCUSSION OF THE INVENTION

I. Definitions

As used herein, the terms set forth with particularity below and grammatical variations used herein have the following definitions. If not otherwise defined, all terms used herein have the meaning commonly understood by a person skilled in the art to which this invention pertains.

A “functionality” refers to a group of atoms that represents a potential reaction site in an organic compound. For example, a monomer of the present invention typically includes a single vinyl functionality (i.e., a single univalent CH₂═CH group) and at least one non-vinyl functionality (e.g., a secondary functionality, a tertiary functionality, and/or the like). Non-vinyl functionalities (e.g., R₂ₐ and R_{2b}) are secondary, tertiary, etc. to the vinyl functionality of the monomers described herein. A mono-vinyl monomer of the invention also includes a 6-membered acetal ring that optionally includes one or more functionalities, e.g., at R₃ and/or R₄. In certain embodiments of the invention, polymers produced from the monomers described herein are cross-linked or branched, e.g., via labile hydrogens, via the non-vinyl groups of R₂, etc.

A “moiety” refers to one of the portions into which a molecule is divided (e.g., a functional group, substituent group, or the like). For example, a monomer of the present invention includes a single vinyl moiety.

A “polymer” refers to a compound that includes two or more monomeric units. A polymer of the present invention includes at least one monomeric unit derived (e.g., through a chemical modification, such as a polymerization reaction, etc.) from a monomer described herein.

The term “substantially quantitative double bond conversion” refers to a polymerization reaction in which greater than 50% by weight of the monomers in the reaction mixture or composition are converted to polymer. In a reaction that includes the monomers of the invention, for example, typically more than 75% of the monomers in the reaction mixture are converted to polymer, more typically greater 85% of the monomers in the reaction mixture are converted to polymer, and still more typically greater 95% of the monomers in the reaction mixture are converted to polymer.

The term “reactivity” is defined as the maximum polymerization rate normalized by the initial monomer concentration in a given polymerization reaction.

II. Mono-Vinyl Photopolymerization Systems

The present invention relates to novel acrylate, acrylamide, methacrylate and methacrylamide monomers bearing substituted and unsubstituted 6-membered cyclic acetal/thioacetal substituents and in some cases secondary and tertiary non-vinyl functionalities positioned between the vinyl and cyclic acetal moieties, their high polymerization reactivity, and the unique material properties of the polymers that they form. The monomers of the invention are mono-vinyl, including only single reactive double bonds. The 6-membered acetal ring structure and relative placement, orientation, chemistry, and electronic characteristics of the acetal substituents and non-vinyl functionalities designed into these novel materials leads to extremely rapid polymerizations and versatile combinations of material properties. Although the monomers of the invention each include only a single vinyl polymerizable moiety, they form complex crosslinked (3-D), insoluble, polymer networks (e.g., rubbery polymer networks, glassy polymer networks, etc.) on time scales that rival those of the industry standard, multi-vinyl containing monomers. Examples that illustrate the reactivity of the monomers of the present invention in comparison to certain multi-vinyl monomers and other aspects of the invention are provided below.

Additionally, in contrast to their multi-vinyl counterparts, the monomers described herein typically react to substantially quantitative double bond conversion. This feature translates into materials with low residual/leachable monomer content, and thus, lower toxicity and a higher resistance to material property changes over time (i.e., an increase in the lifetime or durability of the material). Lower resistance to material property changes over time is often a result of undesirable reactions between oxygen and unreacted double bonds. The rapid and relatively complete polymerization of these novel monomers also translates into minimal required exposure times and intensities, traits that have significance for a wide range of curing applications, e.g., filled and multi-layer polymerizations, in addition to beneficial economic implications, including reduced production costs. This decrease in exposure time and initiation intensity has significance for a wide range of curing applications. Some examples include applications that require cure through a secondary layer, cure of systems containing fillers, which absorb a fraction of the initiating light, and applications that prohibit the use of an inert atmosphere for cure, e.g., in vivo applications. In addition, the physical characteristics, i.e., physical state (solid, liquid), viscosity, refractive index, and absorptivity, of these monomers can also be readily manipulated and tailored for a specific application via subtle changes to the structure and chemistry, as described herein. Furthermore, in certain embodiments, initiator concentrations used in the polymerization reactions can be reduced relative to more conventional protocols without compromising the rate or extent of cure. This reduction positively impacts on the long-term color stability of some polymer products, as initiators are a leading cause of polymer discoloration and long-term degradation reactions. Additional details relating to all aspects of the present invention are provided in, e.g., Kathryn Ann Berchtold, Impact of Monomer Structure and Termination Kinetics on Free Radical Photopolymerizations, Ph.D. Thesis, Department of Chemical Engineering, University of Colorado, November 2001, which is incorporated by reference in its entirety for all purposes.

In particular, the mono-vinyl monomers of the invention correspond to a compound of the general formula (I):

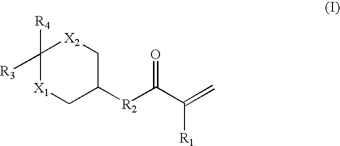

in which R₁ is CH₃ or H and R₂ is (R₂ₐ)ₘWₙ(R_{1b})ₚY_{q}Z. R₂ₐ and R_{2b} are independently selected from carbonates, carbamates, ureas, dithiocarbonates, dithiocarbamates, thiocarbonates, thioureas, trithiocarbonates, and thiocarbamates, and m and p are independently selected from 0 and 1. Further, W is selected from CH₂ and (CH₂)ₜO, Y is selected from CH₂ and (CH₂)ₛO, t and s are integers independently selected from 0 to 50 inclusive, n and q are integers independently selected from 0 to 50 inclusive, and Z is O or NH and is attached to the carbonyl moiety. In addition, R₃ and R₄ are independently selected from H, a substituted or unsubstituted alkyl group, and a substituted or unsubstituted aromatic group, and X₁ and X₂ are independently selected from O and S. Moreover, in a mono-vinyl monomer of the invention:

(a) if Z is O, Y is CH₂, q is an integer from 1 to 4 inclusive, and m, n, and p are 0, then at least one of X₁ and X₂ is S;

(b) if Z is O, W is CH₂, n is an integer from 1 to 4 inclusive, and m, p, and q are 0, then at least one of X₁ and X₂ is S; and,

(c) if Z is O and m, n, p, and q are 0, then at least one of X₁ and X₂ is S.

In certain embodiments, the alkyl group or the aromatic group of R₃ or R₄ includes at least one ring optionally having 3, 4, 5, 6, 7, 8, or more members.

To further illustrate, preferred non-vinyl functionalities (R₂ₐ and R_{2b}) include those of formulae:

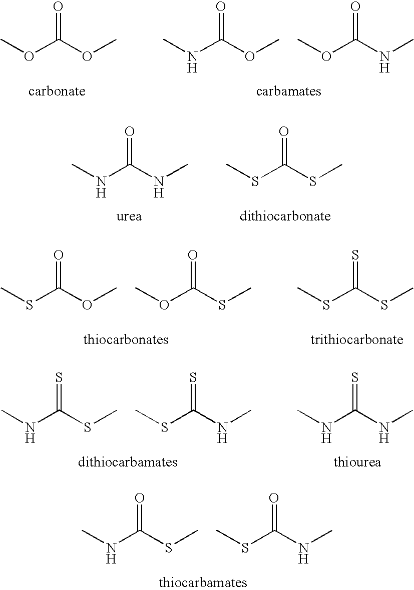

The structures of certain representative preferred monomers of the present invention are provided below in Table I.

TABLE I 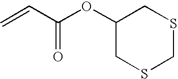
Compound 1 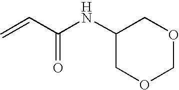
Compound 2 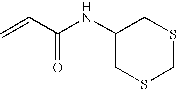
Compound 3 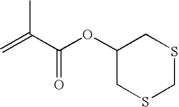
Compound 4 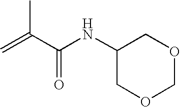
Compound 5 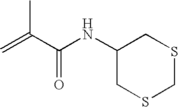
Compound 6 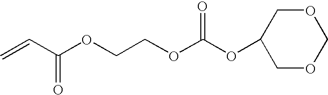
Compound 7 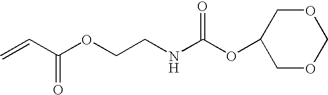
Compound 8 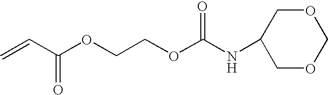
Compound 9 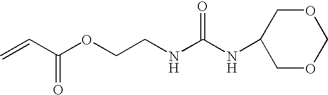
Compound 10 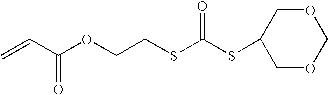
Compound 11 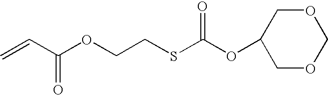
Compound 12 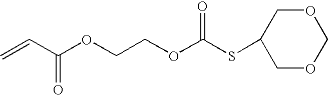
Compound 13 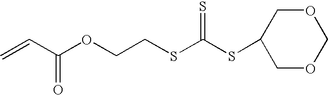
Compound 14 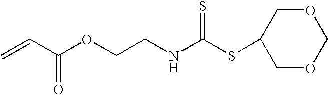
Compound 15 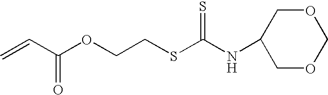
Compound 16 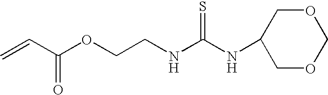
Compound 17 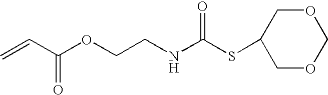
Compound 18 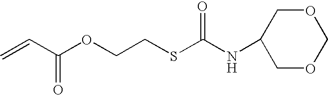
Compound 19 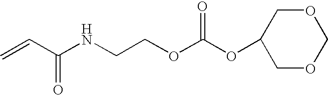
Compound 20 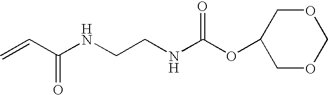
Compound 21 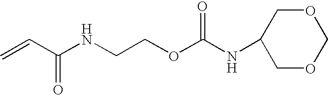
Compound 22 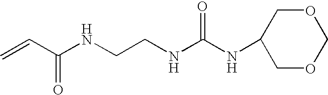
Compound 23 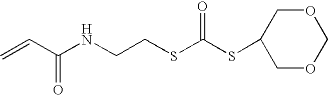
Compound 24 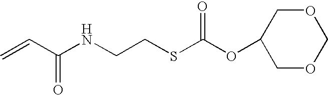
Compound 25 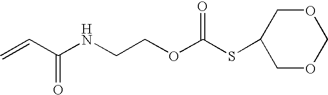
Compound 26 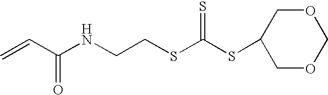
Compound 27 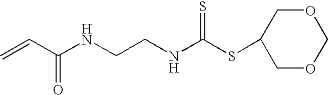
Compound 28 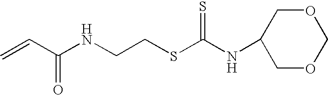
Compound 29 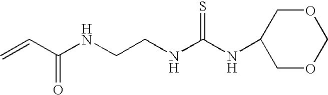
Compound 30 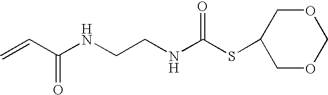
Compound 31 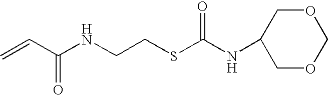
Compound 32 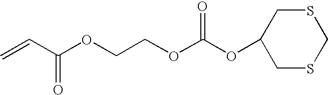
Compound 33 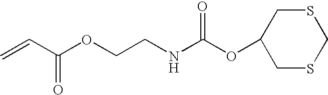
Compound 34 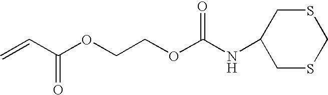
Compound 35 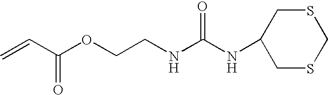
Compound 36 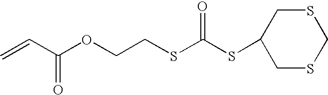
Compound 37 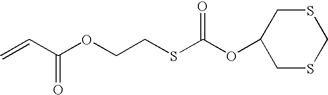
Compound 38 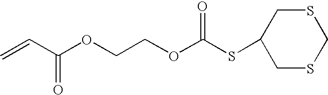
Compound 39 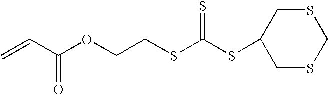
Compound 40 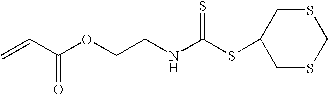
Compound 41 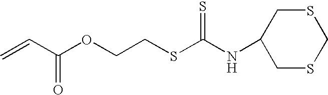
Compound 42 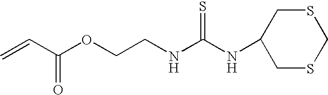
Compound 43 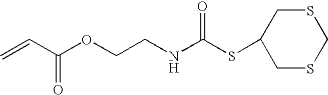
Compound 44 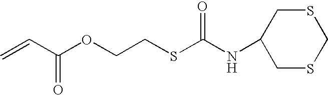
Compound 45 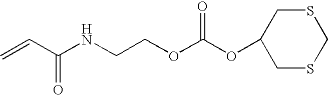
Compound 46 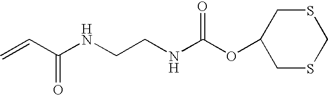
Compound 47 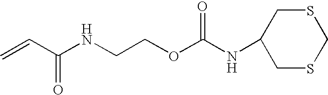
Compound 48 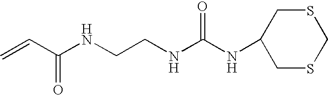
Compound 49 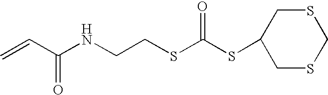
Compound 50 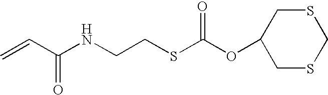
Compound 51 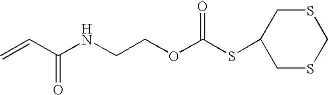
Compound 52 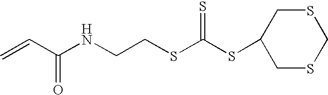
Compound 53 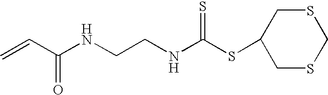
Compound 54 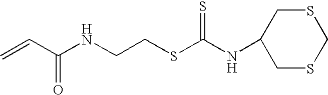
Compound 55 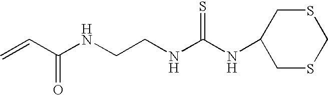
Compound 56 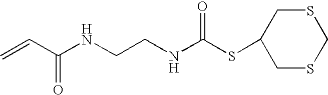
Compound 57 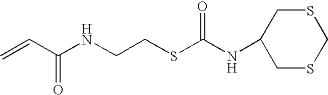
Compound 58 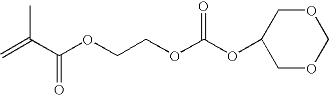
Compound 59 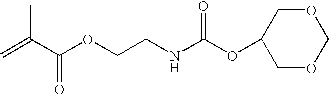
Compound 60 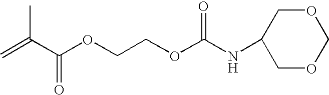
Compound 61 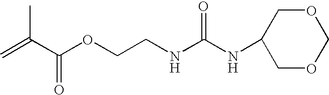
Compound 62 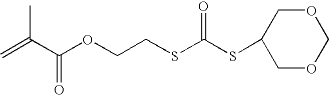
Compound 63 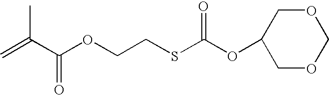
Compound 64 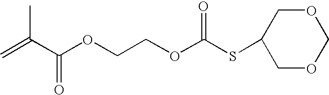
Compound 65 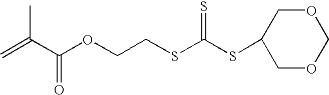
Compound 66 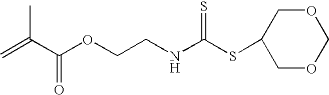
Compound 67 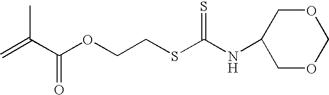
Compound 68 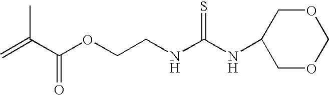
Compound 69 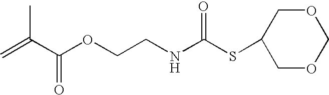
Compound 70 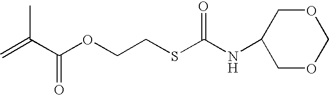
Compound 71 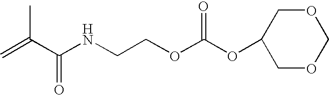
Compound 72 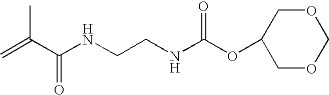
Compound 73 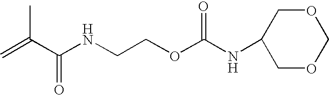
Compound 74 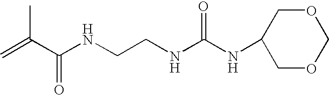
Compound 75 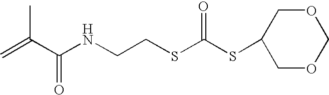
Compound 76 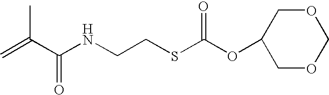
Compound 77 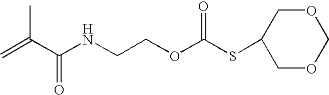
Compound 78 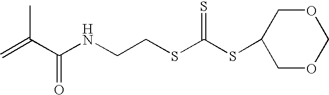
Compound 79 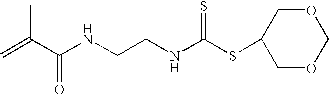
Compound 80 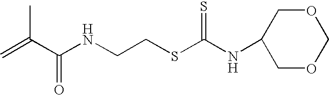
Compound 81 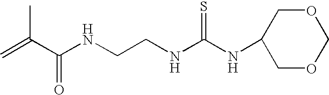
Compound 82 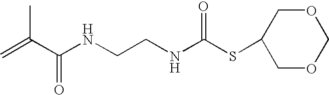
Compound 83 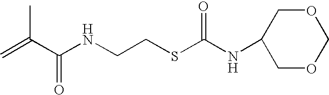
Compound 84 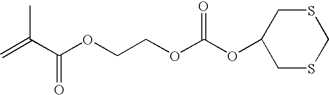
Compound 85 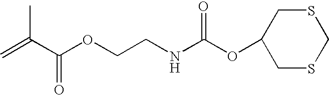
Compound 86 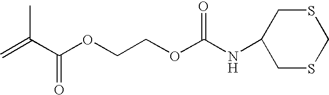
Compound 87 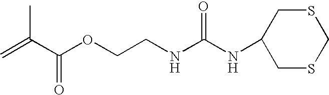
Compound 88 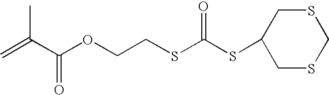
Compound 89 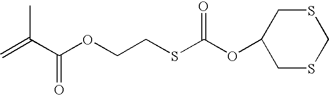
Compound 90 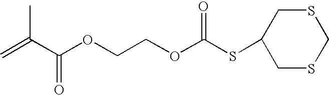
Compound 91 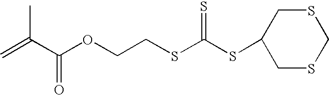
Compound 92 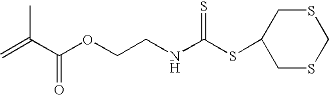
Compound 93 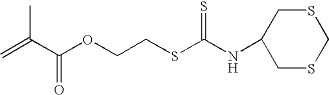
Compound 94 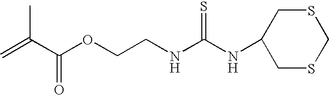
Compound 95 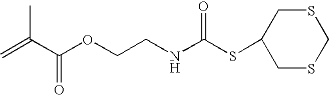
Compound 96 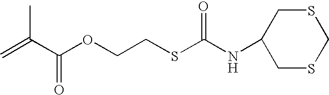
Compound 97 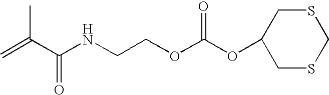
Compound 98 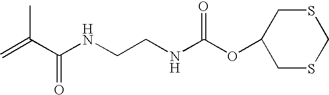
Compound 99 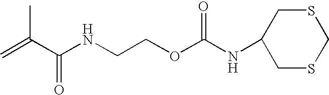
Compound 100 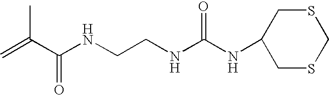
Compound 101 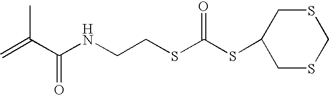
Compound 102 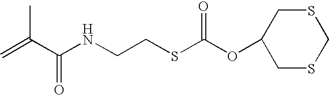
Compound 103 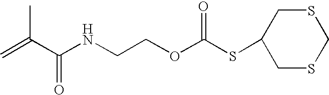
Compound 104 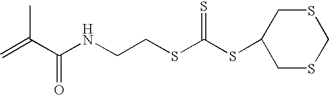
Compound 105 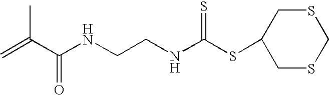
Compound 106 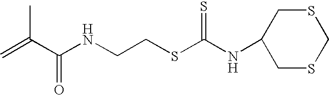
Compound 107 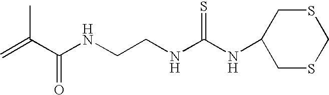
Compound 108 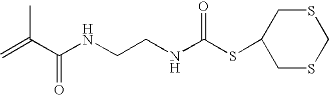
Compound 109 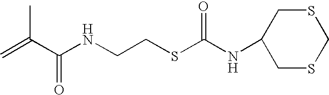
Compound 110 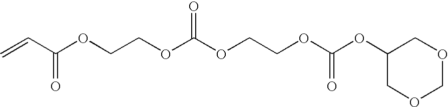
Compound 111 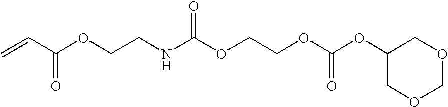
Compound 112 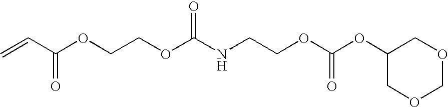
Compound 113 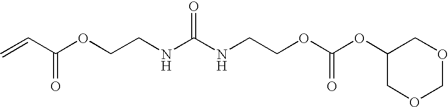
Compound 114 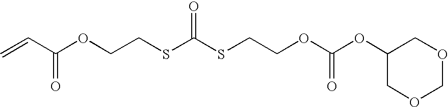
Compound 115 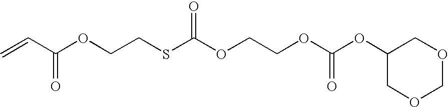
Compound 116 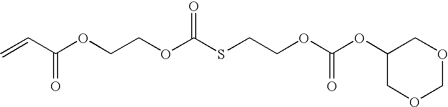
Compound 117 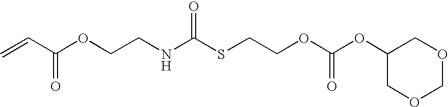
Compound 118 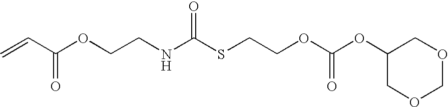
Compound 119 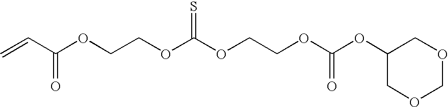
Compound 120 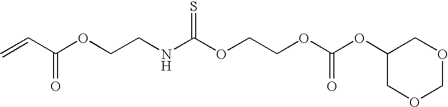
Compound 121 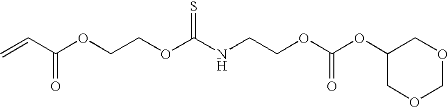
Compound 122 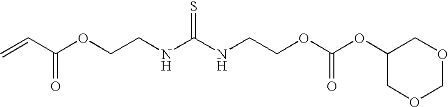
Compound 123 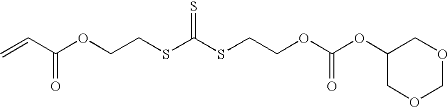
Compound 124 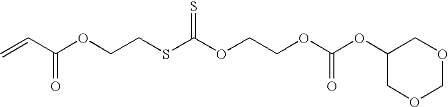
Compound 125 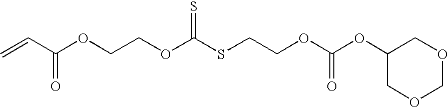
Compound 126 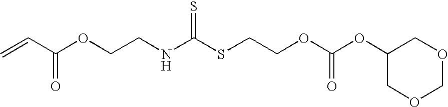
Compound 127 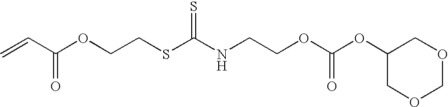
Compound 128 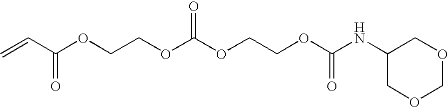
Compound 129 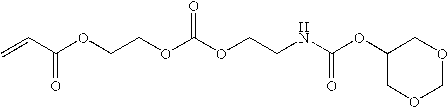
Compound 130 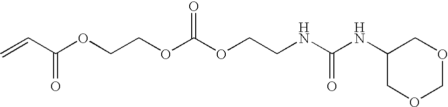
Compound 131 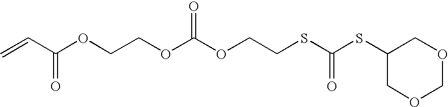
Compound 132 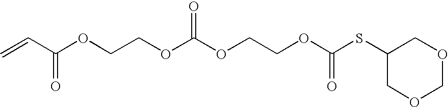
Compound 133 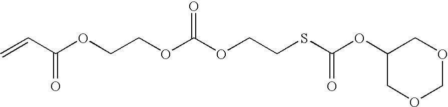
Compound 134 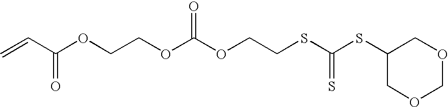
Compound 135 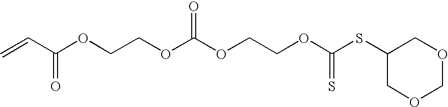
Compound 136 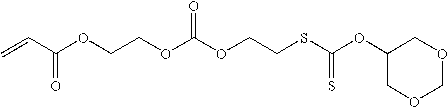
Compound 137 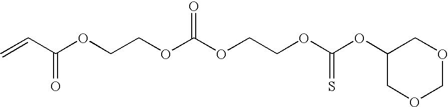
Compound 138 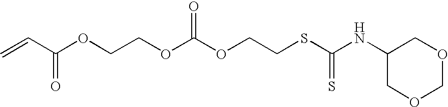
Compound 139 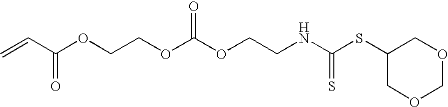
Compound 140 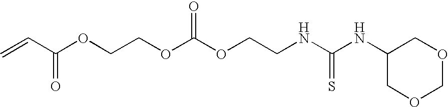
Compound 141 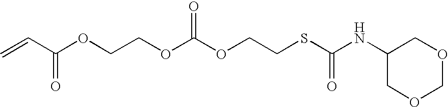
Compound 142 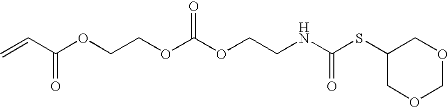
Compound 143 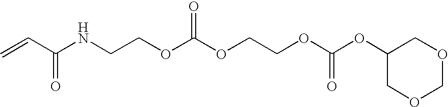
Compound 144 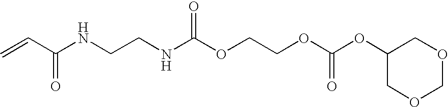
Compound 145 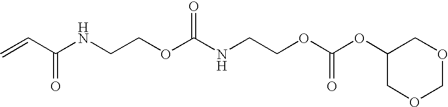
Compound 146 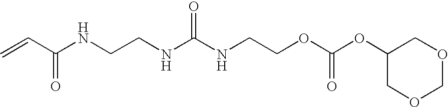
Compound 147 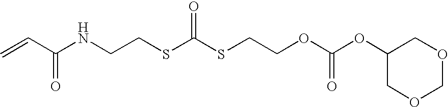
Compound 148 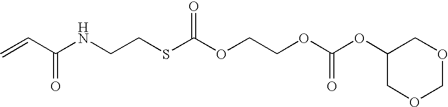
Compound 149 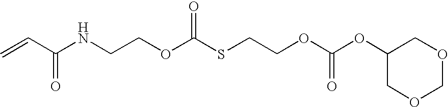
Compound 150 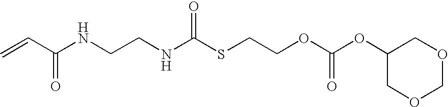
Compound 151 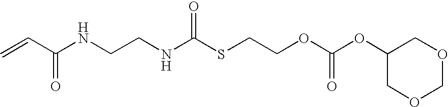
Compound 152 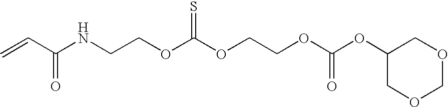
Compound 153 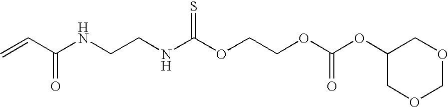
Compound 154 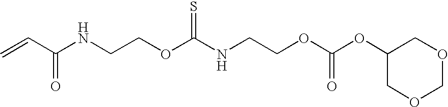
Compound 155 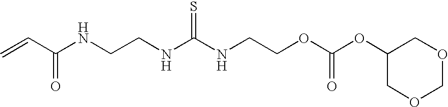
Compound 156 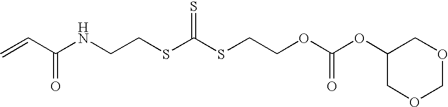
Compound 157 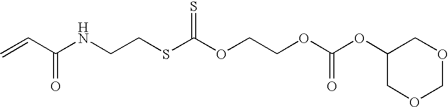
Compound 158 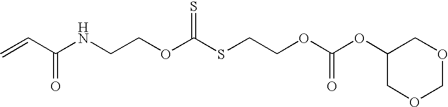
Compound 159 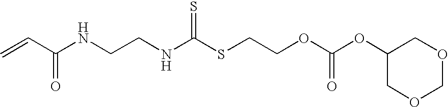
Compound 160 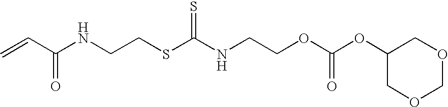
Compound 161 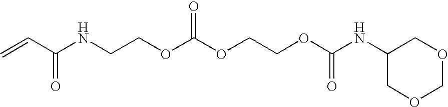
Compound 162 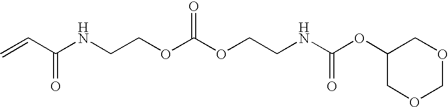
Compound 163 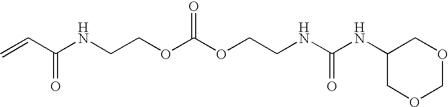
Compound 164 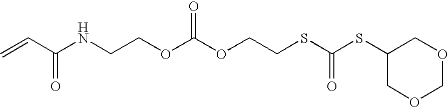
Compound 165 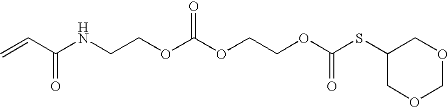
Compound 166 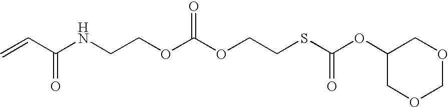
Compound 167 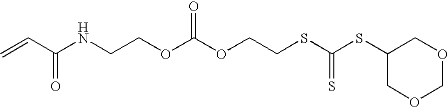
Compound 168 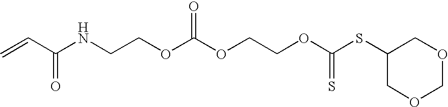
Compound 169 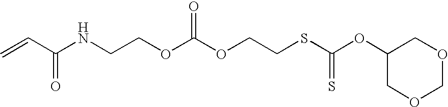
Compound 170 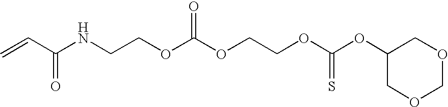
Compound 171 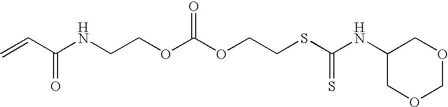
Compound 172 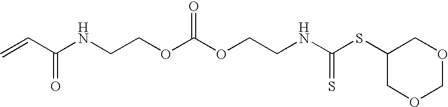
Compound 173 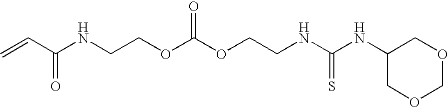
Compound 174 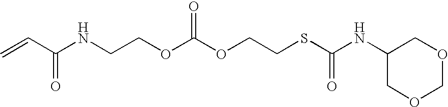
Compound 175 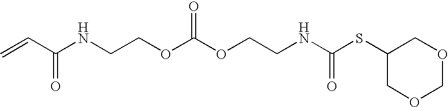
Compound 176
Specific exemplary monomer structures that are included in this invention are presented, referred to, and/or described in this table. Only certain acrylate, acrylamide, methacrylate, and methacrylamide structures are illustrated, but other monomers within the scope of the present invention will be apparent to persons of skill in the art in view of formula (I) described herein. In particular, only cases where alkyl spacer groups (W or Y)
#corresponding to (CH₂)₂ are shown; other alkyl and alkyl glycol spacer groups, e.g., (CH₂)ₜ or [(CH₂)ₜO]ₛ are also optionally included, where t and s are independently selected from integers from 1-50 inclusive. Monomers with single non-vinyl functionalities (R₂ₐ or R_{2b}) and those with multiple non-vinyl functionalities (R₂ₐ and R_{2b}) in any combination (i.e., the same or
#different functionalities) are also claimed herein. The non-vinyl functionalities shown above, which include the carbonate, carbamate, urea, dithiocarbonate, dithiocarbamate, thiocarbonate, thiourea, trithiocarbonate, and thiocarbamate structures are also claimed herein. Additionally, only cases where R₃ and R₄ of the 6-membered acetal and thioacetal moieties are hydrogens are shown. Optionally, R₃ and R₄ independently comprise
#substituted or unsubstituted alkyl groups, or substituted or unsubstituted aromatic groups (e.g., phenyl, benzyl, diphenyl, or other aromatic groups). As mentioned, alkyl groups that are optionally included at R₃ and R₄ can include ring structures having, e.g., 3, 4, 7, 8 or more members. Similarly, when R₃ and R₄ include aromatic groups, they can also include ring structures having, e.g., 3, 4, 7, 8 or more members. Further, only cases where
#X₁ and X₂ are both O or both S are shown. However, the structures of the invention also include those having monothiol acetal groups (i.e., where only X₁ or X₂ is S).

Synthetic methods to produce non-substituted cyclic acetal containing monomers of the invention involve reaction(s) with glycerol formal, which is illustrated below (Structure II). This starting material exists as an equilibrium mixture (approximately equimolar at ambient conditions) of both a five membered and a six membered cyclic acetal alcohol. Thus, reactions utilizing this material to produce vinyl functionalized cyclic acetal containing monomers will yield a mixture of at least two products, one with a 5 membered cyclic acetal substituent and the other with a 6 membered cyclic acetal substituent.

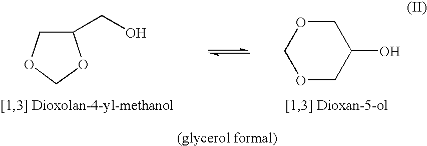

Simple cyclic acetal monomers have been synthesized and polymerized previously; however, no distinction has been drawn between the two structural isomers, nor has effort been put forward to control or characterize the relative isomer concentrations or to isolate a given ring size at any stage of the synthesis or application. As described further below, isomer separations (e.g., using flash chromatography or other techniques) and/or selective reaction schemes are utilized to isolate or selectively produce the 6 membered cyclic acetal monomers of the present invention. Additional details relating to various synthetic techniques that can be adapted for use in the monomer synthesis protocols and polymerization reactions of the present invention are described in, e.g., March, Advanced Organic Chemistry: Reactions, Mechanisms, and Structure, 4^{th} Ed., John Wiley & Sons, Inc. (1992), Carey and Sundberg, Advanced Organic Chemistry Part A: Structure and Mechanism, 4th Ed., Plenum Press (2000), and in the references provided therein. Chemical starting materials and other reaction components useful in the synthesis of the monomers of the present invention are readily available from various commercial suppliers including, e.g., Sigma-Aldrich, Inc. The synthesis and purification of the mono-vinyl monomers of the invention are described further in the examples provided below. From these examples and the general knowledge in the art it will be apparent to one of skill how to synthesize and purify the monomers of the present invention.

The polymers of the invention are produced by reacting at least two monomers with one another in which at least one of the monomers corresponds to a compound of the general formula (I), described above. For example, polymerizable compositions (e.g., radiation curable compositions, etc.) of the invention optionally include only a single type of monomer, e.g., when a homopolymer is sought. When a copolymer is desired, compositions typically include two or more different mono-vinyl monomers of the invention. See, e.g., Table I, above. However, these compositions also optionally comprise other types of monomers including multi-vinyl monomers, such as hexanediol diacrylate, 1,6 hexanediol dimethacrylate, or the like. To further illustrate, a composition optionally comprises a mono-vinyl monomer of the invention, such as cyclic acetal-6 carbamate (OCN) methacrylate, etc. and a multi-vinyl monomer, such as hexanediol diacrylate. In addition, the compositions of the present invention optionally include monomers having other radiation curable functional groups, such as vinylether, fumarate, maleate, oxolane, epoxy, itaconate, and/or other groups. The proportions of the constituent monomers in a composition may also vary according to the mechanical properties desired for the polymer. In certain embodiments, for example, a composition of the invention includes at least one monomer described herein in an amount of at least about 1% by weight of the total amount of components in the composition, preferably at least about 5% by weight, more preferably at least about 10% by weight, even more preferably at least about 15% by weight and still more preferably at least about 25% by weight (e.g., at least about 35%, 45%, 55%, 65%, 75%, or more by weight of the total amount of components in the composition).

As mentioned, the polymerizable compositions used in these processes are typically varied according to the desired material properties (e.g., strength (e.g., elongation strength, tensile strength, etc.), hardness (e.g., pendulum hardness), flexibility, insolubility, etc.) sought in the polymer product. The particular mono-vinyl (meth)acrylic and (meth)acrylamide monomers included in a given composition can include any of the non-vinyl functionalities (R₂ₐ or R_{2b}) described herein or essentially any combination of those functionalities in monomers that comprise multiple non-vinyl functionalities (R₂ₐ and R_{2b}). To illustrate, non-vinyl functionalities are optionally selected according to the type of cross-linking desired in the polymer product.

In addition, polymerizable compositions are further varied based upon the non-vinyl groups (R₃ and R₄) included in the composition. As described above, these groups optionally include hydrogens, or substituted or unsubstituted alkyl groups (e.g., methyl, ethyl, propyl, isopropyl, butyl, isobutyl, sec-butyl, tert-butyl, pentyl, isopentyl, neopentyl, tert-pentyl, or other groups). Alkyl groups are optionally cyclic. In certain embodiments, for example, substituted cycloalkyls include, e.g., cyclic carbonates, cyclic carbamates, cyclic ureas, etc., including those with sulfur substitutions. In certain embodiments, (R₃ and/or R₄) include one or more aromatic groups (e.g., benzyl, phenyl, diphenyl, or other groups).

Monomers are further varied by including alkyl spacer groups (e.g., (CH₂)ₜ) of selected lengths. For example, t is typically an integer from 1 to 50 inclusive, more typically an integer from 1 to 25 inclusive, and still more typically integer from 1 to 10 inclusive (e.g., 2, 3, 4, 5, 6, 7, 8, or 9). In some embodiments, spacer groups are alkyl glycol groups (e.g., [(CH₂)ₜO]ₛ). In these embodiments, t and s are also typically integers independently selected from 1 to 50 inclusive, more typically integers independently selected from 1 to 25 inclusive, and still more typically integers independently selected from 1 to 10 inclusive (e.g., 2, 3, 4, 5, 6, 7, 8, or 9). Additional details relating to the particular monomers selected for inclusion in a given composition are described above and in the examples provided below.

In some embodiments, compositions of the invention further include quantities (e.g., a few % by weight) of photocrosslinking or photo-polymerization initiators, solvents/diluents (e.g., reactive and/or non-reactive diluents), photosensitizers/synergists (e.g., diethylamine, triethylamine, ethanolamine, ethyl 4-dimethylaminobenzoate, 4-dimethylaminobenzoic acid, and the like), and/or additives typically utilized in polymerizable compositions. Exemplary initiators which are optionally utilized include benzoin ethers and phenone derivatives such as benzophenone or diethoxyacetophenone, either by themselves or in combination with a tertiary amine, e.g., methyldiethanolamine, etc. More specific exemplary photo-polymerization initiators include, e.g., 3-methylacetophenone, xanthone, fluorenone, fluorene, 2-hydroxy-2-methyl-1-phenylpropan-1-one, triphenylamine, thioxanethone, diethylthioxanthone, 2,2-dimethoxy-2-phenylacetophenone, benzyl methyl ketal, 2,4,6-trimethylbenzoyldiphenylphosphine, and the like. Other initiators that are also optionally utilized are generally known in the art to which this invention pertains. Mixtures of initiators are also optionally utilized. Photo-polymerization initiators are available from a variety of commercial suppliers including, e.g., Ashland, Inc., UCB, BASF, Ciba Specialty Chemicals Co., Ltd., etc. Although compositions having higher initiator contents are optionally utilized, compositions with a low initiator content (e.g., 1 wt % or less), or containing no initiator, are typically preferred. Compositions with lower levels of an initiator are typically more transparent to UV or other forms of electromagnetic radiation, which makes it possible to polymerize in greater depths, e.g., in thicknesses of 1 cm or more. In addition to limiting cure depth (i.e., the maximum achievable polymer thickness), initiators can also lead to polymer discoloration and negatively impact other polymer properties, such as polymer durability, etc.

Polymerizable compositions (e.g., coating compositions, etc.) utilized to produce the polymers of the present invention may also contain essentially any additive that is typically utilized in these process, such as agents for adjusting the surface gloss of the polymer, surfactants, fillers, colorants, antioxidants, UV absorbers, heat polymerization inhibitors, light stabilizers, silane coupling agents, coating surface improvers, leveling agents, preservatives, plasticizers, lubricants, solvents, aging preventives, and the like. In certain embodiments, amine compounds (e.g., diethylamine, diisopropylamine, diallylamine, etc.) can be added to polymerizable composition to prevent the generation of hydrogen gas. These and other additives are generally known in the art and readily available from many different commercial sources, such as Ashland, Inc., UCB, Sigma-Aldrich, Inc., BASF, Ciba Specialty Chemicals Co., Ltd., Sankyo Co., Ltd., Sumitomo Chemical Industries Co., Ltd., Shin-Etsu Chemical Co, Ltd., and the like.

The polymerization reactions of the invention are performed under varied conditions. For example, the reacting step optionally includes one or more of, e.g., irradiating a composition comprising the monomers, heating a composition comprising the monomers, adding at least one catalyst to a composition comprising the monomers, and/or the like. The radiation utilized may be, for example, electromagnetic radiation, electron bombardment, or nuclear radiation. In certain embodiments, for example, an article or other substrate coated with a polymerizable composition described herein is exposed to the radiation source (e.g., a UV or electron beam radiation source), for a selected period of time. To further illustrate, one photon and/or two photon polymerizations are optionally utilized. Additional details relating to single and multiple photon polymerizations are provided in, e.g., Macak et al. (2000) “Electronic and vibronic contributions to two-photon absorption of molecules with multi-branched structures,” J. Chem. Phys. 113(17):7062, Luo et al. (2000) “Solvent induced two-photon absorption of push-pull molecules,” J. Phys. Chem. 104:4718, and Luo et al. (1994) “One- and two-photon absorption spectra of short conjugated polyenes,” J. Phys. Chem. 98:7782. The intensity of light utilized to polymerize the monomers of the invention is typically between about 1 and about 50 mW/cm², more typically between about 1 and about 25 mW/cm², and still more typically between about 1 and about 10 mW/cm² (e.g., about 5 mW/cm²). In addition, radiation exposure times are also varied, e.g., according to the particular monomer(s) used, the extent of double bond conversion desired, etc. To illustrate, the polymerizable compositions described herein are typically exposed to the particular radiation source from a few milliseconds to several minutes or more. Typically, the monomers of the present invention achieve substantially quantitative double bond conversion in less than 60 seconds (e.g., about 20 seconds or less) at about 5 mW/cm², i.e., substantially quantitative double bond conversion is achieved at a dose typically less than 0.1 J/cm². Furthermore, polymerization temperatures are typically between 0° C. and 100° C. In preferred embodiments, polymerizations are performed at or near room temperature (e.g., 20-25° C.).

In some embodiments of the invention, a polymer produced according to the methods described herein includes compounds of formula (III):

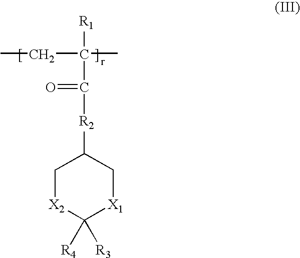

in which R₁-R₄ of each monomeric unit are independently selected as described above with respect to the monomer having the formula (I) and r is an integer greater than 1. In preferred embodiments, a polymer of the invention includes at least one monomeric unit derived from the compound of formula (I). For example, polymers can include selected combinations of mono-vinyl and multi-vinyl monomeric units. The homopolymers and copolymers of the invention can be, e.g., linear, branched, and/or cross-linked (e.g., via labile hydrogens, via non-vinyl functionalities (R₂ₐ or R_{2b}), etc.). Included among the superior material properties of the polymers described herein is that they are typically substantially insoluble. Additional characteristic properties of these polymers are described throughout this disclosure.

The polymers of the invention can be included in essentially any article of manufacture, e.g., whether the polymer forms the structure of the article, a component part of the structure, a coating (e.g., a primary coating, a secondary coating, etc.) of an article or substrate, or the like. Accordingly, no attempt is made herein to describe all of the possible applications of the polymers of the present invention. However, certain exemplary embodiments are provided to further illustrate the present invention, but not to limit the invention. In particular, the polymers described herein are optionally included in articles, such as, dental restorative and other biomedical materials, fiber optic materials, lithographic materials (e.g., resists, for applications such as semiconductors, microfluidic devices, microelectronics, MEMS/NEMS, and nanolithography, etc.), membranes, adhesives, printing plates, inks, holographic materials, biomaterials, and the like. The polymers of the invention are also optionally utilized as coatings, e.g., for optical fibers, optical disks, graphic arts, paper, wood finishes, ceramics, glass, and the like. Additional aspects of the present invention are provided in, e.g., the examples below, which illustrate certain monomer synthesis and purification protocols, and provide comparisons that illustrate some of the superior properties of the monomers described herein, including high reactivities and extents of monomer conversion to polymer. Additional details of the present invention are also provided in, e.g., Kathryn Ann Berchtold, Impact of Monomer Structure and Termination Kinetics on Free Radical Photopolymerizations, Ph.D. Thesis, Department of Chemical Engineering, University of Colorado, November 2001, which is incorporated by reference in its entirety for all purposes.

### VI. EXAMPLES

The present invention will hereinafter be described in further detail by Examples. It should however be borne in mind that this invention is by no means limited to or by the examples. Incidentally, all designations of “%” mean wt. % unless otherwise specifically designated. In particular, the synthetic and purification methods used to produce certain illustrative monomers of the present invention are provided. Monomers with identical synthetic methods are grouped under a single heading. Included in synthesis and purification sections are the 500 MHz 1H NMR frequency shifts in ppm, the boiling point (° C.), the pressure (mm Hg) at which the boiling point was determined, and the melting point, where applicable. The monomer abbreviations are the means of identification in the analysis chapters. Additionally provided below are examples that illustrate the effects of secondary functionalities on monomer reactivities and extents of conversion.

A. Monomer Synthesis and Purification

It is important to note that the synthesis methods employed herein to produce the nonsubstituted cyclic acetal systems involved reactions with glycerol formal. As mentioned above, this starting material exists as an equilibrium mixture (approximately equimolar at ambient conditions) of both a five membered and a six membered cyclic acetal alcohol. After reaction with acryloyl chloride, the two primary products were separated using flash chromatography. Multiple fractions were collected at various isomer concentrations. Simple cyclic acetal monomers have been synthesized and polymerized previously; however, no distinction has been drawn between the two structural isomers, nor has effort been put forward to control or characterize the relative isomer concentrations or isolate a given ring size at any stage of the synthesis or application. As described herein, isomer separations or the use of selective reaction schemes to isolate or selectively produce the 6 membered cyclic acetal products are preferred. From these examples and the general knowledge in the art it will be apparent to one of skill how to synthesize and purify the monomers of the present invention.

1. Cyclic Acetals

### Example 1

### Cyclic Acetal (meth)acrylate

| | |
|---|---|
| IUPAC name: | (2-Methyl)-acrylic acid [1,3]dioxan-5-yl |
| | ester; |
| | (2-Methyl)-acrylic acid [1,3]dioxolan-4-yl- |
| | methyl ester |
| Common name: | cyclic acetal-6 methacrylate |
| | cyclic acetal-5 methacrylate |
| Abbreviation: | cyclic acetal-6 MA |
| | cyclic acetal-5 MA |
| 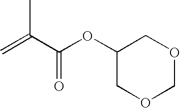 | 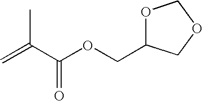 |
| IUPAC name: | Acrylic acid [1,3]dioxan-5-yl ester; |
| | Acrylic acid [1,3]dioxolan-4-ylmethyl |
| | ester |
| Common name: | cyclic acetal-6 acrylate |
| | cyclic acetal-5 acrylate |
| Abbreviation: | cyclic acetal-6 Acr |
| | cyclic acetal-5 Acr |
| 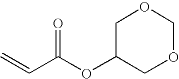 | 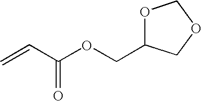 |

Six grams of glycerol formal, 7 g of triethylamine and 100 ml of ethyl acetate were added to a three-necked flask in an ice water bath, equipped with a magnetic stirrer, reflux condenser and N₂ gas purge. (Meth)Acryloyl chloride was added dropwise to the solution while maintaining the temperature below 5° C. The reaction was continued at room temperature for 6 hours. After the reaction was complete, the product was filtered and the filtrate washed with 1 wt % aqueous NaOH solution, 1 wt % aqueous HCl solution, and three times with saturated NaCl solution. The product was then dried over Na₂SO₄ overnight and the solvent was removed under vacuum. The crude product was purified by column chromatography on silica gel using hexane/ethyl acetate (3/1 by volume) eluent.

NMR (CDCl3) (cyclic acetal-(5/6) MA) δ6.05(d, 1H), δ5.6(d, 1H), δ5.05-4.65(m, 5H), δ4.05-4.25(m, 4H), δ4(n, 5H), 63.7(m, 1H), δ1.9(d, 3H).

NMR (CDCl3) (cyclic acetal-(5/6) Acr) δ6.4(q, 1H), δ66.05(m, 1H), δ5.8(q, 1H), δ5.05-4.65(m, 5H), δ4.05-4.25(m, 4H), δ4(m, 5H), δ3.7(m, 1H).

### Example 2

### Ethyl Cyclic Acetal Acrylate

| | |
|---|---|
| IUPAC name: | (5-ethyl-1,3-dioxan-5-yl)methyl prop-2-enoate |
| Common name: | 5-Ethyl-1,3-dioxane-5-methoxyl acrylate |
| Abbreviation: | ethyl cyclic acetal-6 Acr |

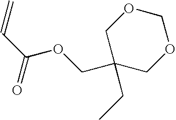

Ten grams of 5-ethyl-1,3-dioxane-5-methanol, 10 ml of triethylamine, and 200 ml of chloroform were mixed in a flask, equipped with a magnetic stirrer and N₂ gas purge in an ice-water bath. Acryloyl chloride (5.2 ml) was added dropwise to the solution while maintaining the temperature below 5° C. The reaction was continued at room temperature overnight. The reaction mixture was filtered, and the liquid phase was washed with saturated NaCl solution three times followed by drying over Na₂SO₄ overnight. After removing the solvent, 10 grams of the crude product was obtained with a yield of 73.5%. Four grams of the crude product was purified by chromatography on silica gel with a hexane/ethylene acetate (3/1 by volume) eluent.

NMR (CDCl3) (ethyl cyclic acetal-6 Acr) δ6.4(d, 1H) δ6.05(q, 1H), δ5.8(d, 1H), δ4.9(d, 1H), δ4.6(d, 1H), δ4.2(s, 2H), δ3.8(d, 2H), δ3.4(d, 2H), δ1.2(q, 2H), δ0.8(t, 3H).

### Example 3

### Cyclic Acetal Carbamate (OCN) Acrylate

| | |
|---|---|
| IUPAC name: | Acrylic acid 2-([1,3]dioxan-5-yloxycarbonylamino)-e- |
| | thyl ester |
| | Acrylic acid 2-([1,3]dioxolan-4-ylmethoxycarbonyla- |
| | mino)-ethyl ester |
| Common name: | cyclic acetal-6 carbamate (OCN) acrylate |
| | cyclic acetal-5 carbamate (OCN) acrylate |
| Abbreviation: | cyclic acetal-6 OCN Acr |
| | cyclic acetal-5 OCN Acr |

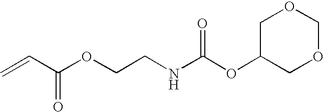

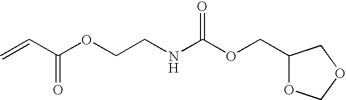

Glycerol formal (20 g) and 30 ml of triethylamine were dissolved in 150 ml of methylene chloride in a three-necked flask, equipped with a magnetic stirrer, reflux condenser and N₂ gas purge in an ice bath. Then, bi(1,1,1-trichloromethyl)carbonate (20 g, 98%) in methylene chloride was added dropwise over a 5 hour period. The reaction was continued for 24 hours at room temperature. The formation of glycerol chloroformate was confirmed by FTIR spectroscopy. The trimethylsilane-protected ethanolamine (TMSi—O-Ethyleneamine) was prepared by dissolving 12.2 g of ethanolamine (99.5+%, redistilled) and 21.5 ml of 1,1,1,3,3,3-hexamethyldisilazane (97%) in 50 ml of toluene at 95-100° C. for 5 hours. The TMSi—O-ethyleneamine solution was carefully added to the glycerol chloroformate solution at 5° C. Following the addition, the reaction was continued at room temperature overnight. Subsequently, the trimethylsilane-protected glycerol carbamate alcohol (TMSi-U-acetal) was hydrolyzed at room temperature in a methanol/water solution (pH≧10) for 24 hours yielding the glycerol carbamate alcohol. Glycerol carbamate alcohol (3.5 g) and 3 ml of triethylamine were mixed in 50 ml of chloroform. A mixture of 20 ml chloroform and 3 ml acryloyl chloride was added dropwise into the glycerol carbamate alcohol solution. The temperature of the reaction mixture was gradually increased to room temperature overnight. Then the mixture was washed with 1 wt % aqueous NaOH, 1 wt % aqueous HCl solutions and three times with saturated NaCl solution. After drying with Na₂SO₄ overnight, the solvent was removed under vacuum, and the product was purified by column chromatography using a silica gel column. About 1 g of the crude glycerol carbamate acrylate product was obtained. The rest of the glycerol carbamate alcohol was reacted with 15.4 gram of acryloyl acrylate by using 25 ml of triethylamine as catalyst in 150 ml of ethyl acetate. After filtering, washing, and drying as described above, the crude product was purified by chromatography on silica gel with hexane/ethylene acetate (1/1 by volume) elution. The product obtained contained a mixture of the five and six membered acetals as described herein.

NMR (CDCl3) (cyclic acetal OCN Acr) δ6.4(d, 1H) δ6.05(q, 1H), δ5.8(d, 1H), δ5.2(s, 1H), δ5.05(s, 1H), δ4.6-5.01(m, 2.5H), δ3.9-4.3(m, 6H), δ3.4-3.7(m, 2.5H).

### Example 4

### Cyclic Acetal Carbamate (OCN) Methacrylate

| | |
|---|---|
| IUPAC name: | 2-Methyl-acrylic acid 2-([1,3]-dioxan-5-yloxycarbo- |
| | nylamino)-ethyl ester; |
| | 2-Methyl-acrylic acid 2-([1,3]-dioxolan-4- |
| | ylmethoxycarbonylamino)-ethyl ester |
| Common name: | Cyclic acetal-6 carbamate (OCN) methacrylate |
| | Cyclic acetal-5 carbamate (OCN) methacrylate |
| Abbreviation: | Cyclic acetal-6 OCN MA |
| | Cyclic acetal-5 OCN MA |

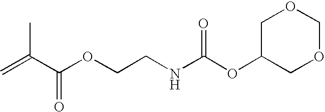

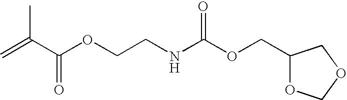

Glycerol formal (3.5 g), two drops of dibutyltin dilaurate, and 50 ml of dichloromethane were introduced into a three-necked flask in ice water bath equipped with a magnetic stirrer, reflux condenser, and N₂ gas purge. 2-Isocyanatoethyl methacrylate (4.5 ml) was added dropwise to the solution after which the temperature was gradually increased to room temperature. The reaction mixture was stirred for two days until the isocyanate IR peak at 2270 cm⁻¹ completely disappeared. The mixture was then washed with 1 wt % aqueous NaOH solution, 1 wt % aqueous HCl solution, and three times with saturated NaCl solution. The organic phase was dried over Na₂SO₄ overnight and the solvent was removed under vacuum. The crude product was recrystallized from chloroform/hexane (1/3 by volume) solution. The product obtained contained a mixture of the five and six membered acetals as described herein. Different five to six membered ring ratios were obtained via flash chromatography of the product.

NMR (CDCl3) (cyclic acetal OCN MA) δ6.05(s, 1H), δ5.58(s, 1H), δ5.2(s, 1H), δ5.05(s, 1H), δ4.6-5.01(m, 2.5H), δ3.9-4.3(m, 6H), δ3.4-3.7(m, 2.5H), δ1.9(s, 3H).

M.P: 82° C. (Temperature where complete melting of the 5 and 6 membered mixture was obtained.).

B. Polymerizations

1. Effect of 5 and 6 Membered Ring Composition on Cyclic Acetal Polymerization

The simple comparison of the two products resulting from the reaction of glycerol formal with acryloyl chloride (compound of the formula (I), where R₁ and R₃═H and R₂ is not present, and a 5 membered version where R₂═CH₂) illustrate clearly the reactivity difference between the two materials. Flash chromatography was used to separate the two products. Multiple fractions were collected at various co-monomer concentrations and then polymerized to characterize the materials. The systems denoted here as 5 membered and 6 membered cyclic acetal acrylate are in fact compositions consisting of less than 100% of the desired ring size, ˜93% 5 membered and ˜97% 6 membered, respectively.

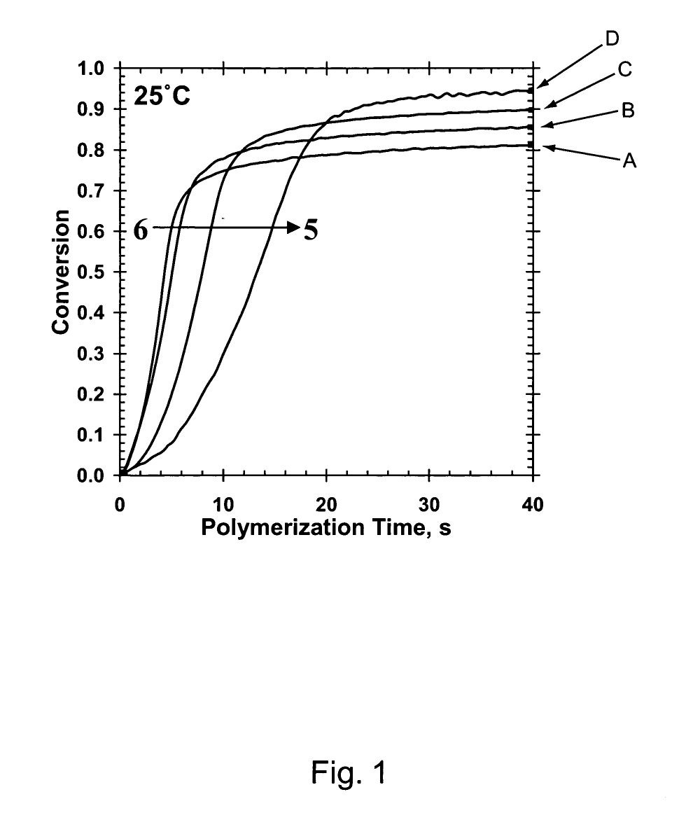

The kinetics of several different acetal compositions ranging from mostly 5 membered (˜93%) to mostly 6 membered (˜97%) were evaluated. The steady state polymerization kinetics as a function of 5 and 6 membered ring composition are presented in FIG. 1. As shown, the compositions (6 membered:5 membered) presented range from (A) 97:3→(B) 80:20→(C) 50:50→(D) 7:93. The polymerization conditions included a light intensity of 5 mW/cm², an initiator concentration of 0.1 wt % DMPA, and a polymerization temperature of 25° C. As shown, polymerization rate decreased and final conversion increased as 5 membered ring content was increased. That is, the polymerization rate increased with increasing 6 membered ring concentration. Unsteady state analysis indicated an increase in the propagation kinetic constant upon shifting from a system of primarily 5 membered cyclic acetal to one comprised of mostly the 6 membered ring structure.

2. Comparison of the 6 Membered Acetal Acrylate to the Divinyl HDDA Polymerization

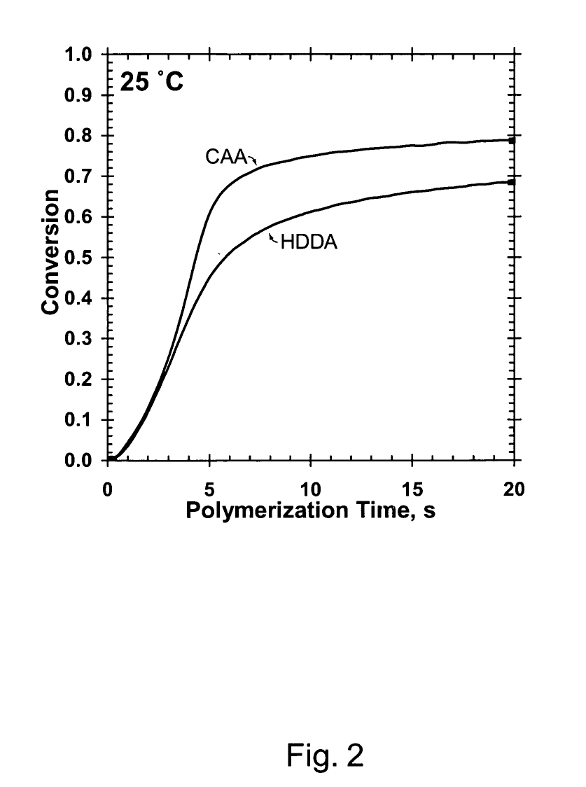

A comparison to the commonly used divinyl monomer 1,6 hexanediol diacrylate (HDDA) illustrates the high reactivity of the mostly 6 membered cyclic acetal acrylate (CAA) (6 membered:5 membered 97:3) monomer (FIG. 2). The polymerization conditions included a temperature of 25° C., an initiator concentration of 0.1 wt %, and a light intensity of 5 mW/cm². As shown, the 6 membered acetal exhibited a reactivity that rivals that of the commonly used divinyl HDDA while achieving higher double bond conversion. This is an interesting result considering that this simple acetal acrylate is among the least reactive of the 6 membered acetal acrylate materials of the present invention.

The results presented above suggest that monomer reactivity increases with an increase in acetal ring size from a 5 to a 6 membered ring. However, contributors to this effect span beyond the size of the cyclic group. Acetals without vinyl group substitution and with allylic substitution have been added previously to polymerization systems and their impact on polymerization evaluated. Those studies demonstrated the importance of factors such as substitution at the acetal carbon, i.e., R₃ or R₄. The nature of the substitution affects the probability of abstraction from that location and thus, the probability of the ring cleavage that accompanies such abstraction. No evidence of a change in abstractability as a result of ring size is found in the literature. Correspondingly, acetal ring substitution or lack thereof, is also utilized in these materials to vary both reactivity and material properties.

3. Effect of Introducing Second or Multiple Non-Vinyl Functional Groups

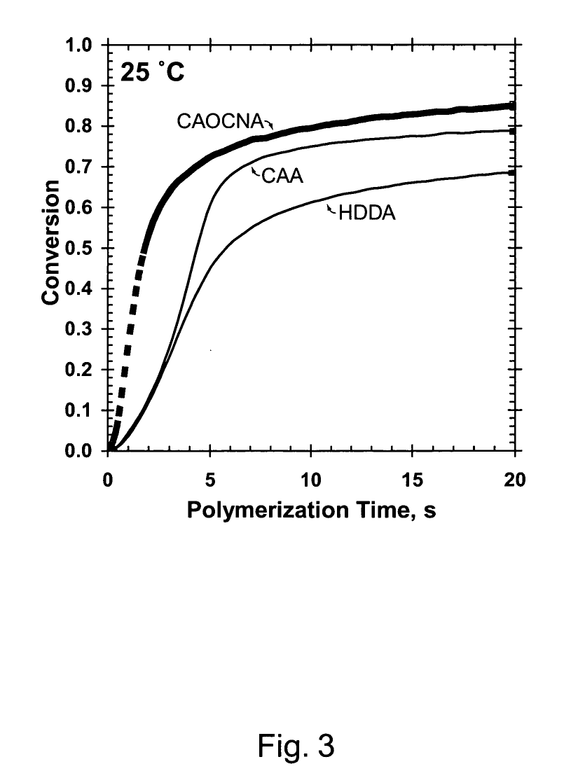

The introduction of the second or multiple non-vinyl functional group(s) (e.g., R₂ₐ and/or R_{2b}) has also been shown to enhance monomer reactivity. For example, the simple incorporation of a carbamate functionality in the R₂ position of an otherwise unsubstituted acetal acrylate monomer yielded a factor of 4 increase in maximum polymerization rate over that of the 6 membered acetal acrylate without a secondary functionality and the divinyl HDDA polymerization (FIG. 3). In particular, FIG. 3 shows a comparison of the cyclic acetal (5/6: 27/73) OCN acrylate (CAOCNA) with the 6 membered acetal acrylate (6 membered:5 membered 97:3) (CAA) and the divinyl HDDA polymerizations. The polymerization conditions included a temperature of 25° C., and initiator concentration of 0.1 wt % DMPA, and a light intensity of 5 mW/cm². This result is even more interesting when one considers that the result in FIG. 3 is not for a pure 6 membered ring substituted material, but merely contained ˜73% of the 6 membered cyclic acetal substituted carbamate acrylate (IV) and ˜27% of the less reactive 5 membered (V).

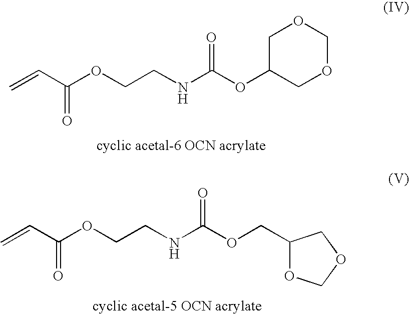

4. Effect of Temperature on Cyclic Acetal OCN Acrylate Polymerization

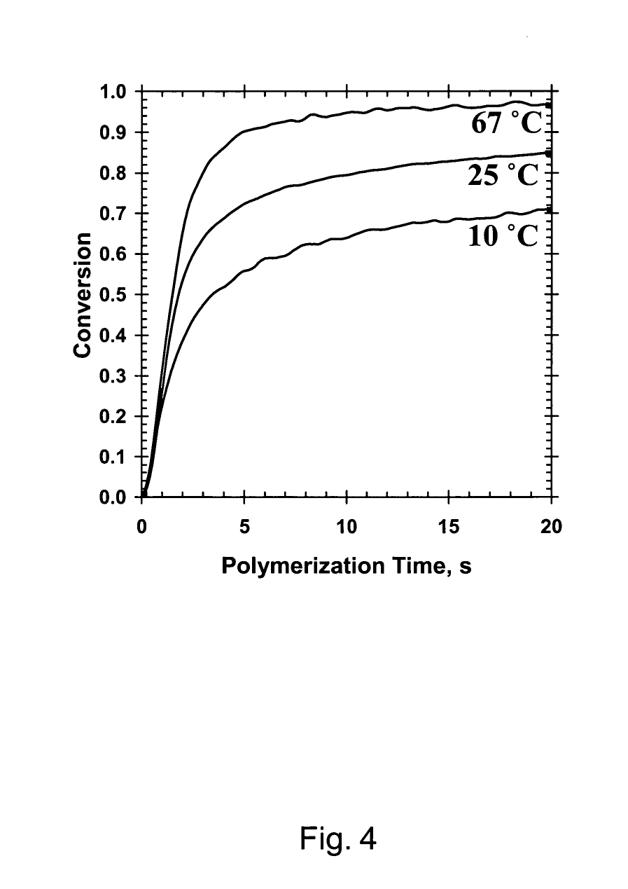

Evaluation of the cyclic acetal (5/6: 27/73) OCN acrylate steady state polymerization kinetics over the 10-67° C. temperature range (specifically at 10, 25, and 67° C.) indicated minimal effect of polymerization temperature on cure rate (FIG. 4). The polymerization conditions included an initiator concentration of 0.1 wt % DMPA and a light intensity of 5 mW/cm 2. This trait of this class of materials makes their use in applications where non-ambient polymerization conditions are necessary appealing, as the typical decrease in reactivity with decreasing temperature is not observed.

5. The Effect of Temperature on the Initiatorless Polymerizations

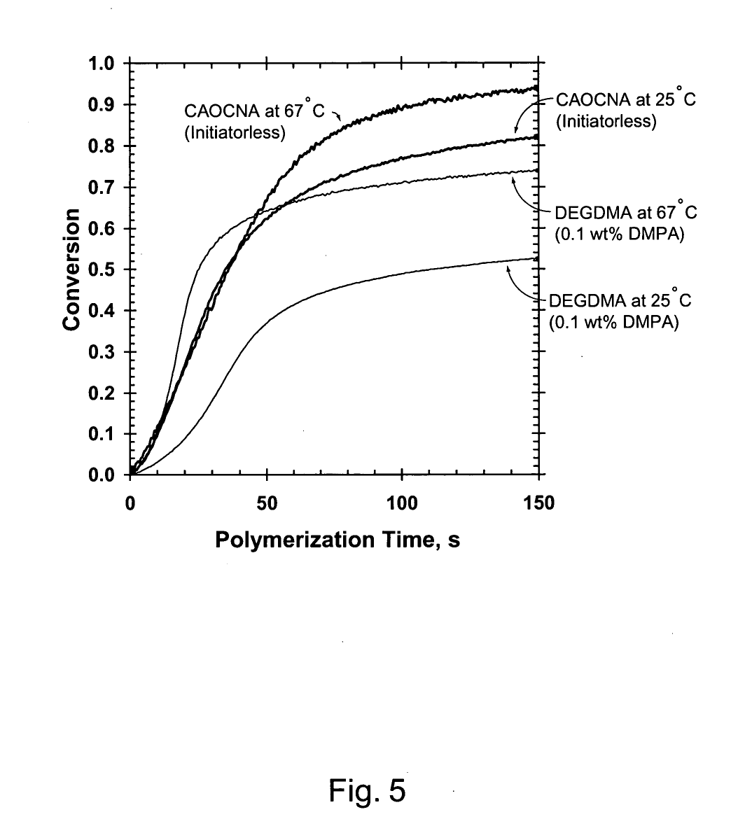

Yet another feature that makes this class of material unique are their initiatorless polymerization characteristics. As shown in FIG. 5, for example, the polymerization of the cyclic acetal (5/6: 27/73) carbamate acrylate (CAOCNA) presented above in the absence of initiator occurred at a rate that rivaled that of a commonly used dimethacrylate monomer, DEGDMA (presented for reference), in the presence of 0.1 wt % UV active initiator, DMPA at 25 and 67° C. An irradiation intensity of 5 mW/cm² was used to induce polymerization. The initiatorless polymerization was also relatively independent of polymerization temperature. Although the polymerization rates obtained do not compare favorably to the rates of this monomer in the presence of initiator, such initiatorless polymerization has applications where toxicity or discoloration due to initiator are not acceptable.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

What is claimed is:

1. A monomer corresponding to a compound of formula (I): 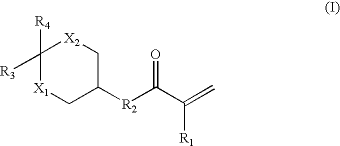
wherein
R₁ is CH₃ or H,
R₂ is (R₂ₐ)ₘWₙ(R_{2b})ₚY_{q}Z, wherein
R₂ₐ and R_{2b} are independently selected from carbonates, carbamates, ureas, dithiocarbonates, dithiocarbamates, thiocarbonates, thioureas, trithiocarbonates, and thiocarbamates,
m and p are independently selected from 0 and 1,
W is selected from CH₂ and (CH₂)ₜO,
Y is selected from CH₂ and (CH₂)ₛO,
t and s are integers independently selected from 0 to 50 inclusive,
n and q are integers independently selected from 0 to 50 inclusive,
Z is O or NH and is attached to the carbonyl moiety,
R₃ and R₄ are independently selected from H, a substituted or unsubstituted alkyl group, and a substituted or unsubstituted aromatic group, and
X₁ and X₂ are independently selected from O and S;
wherein
(a) if Z is O, Y is CH₂, q is an integer from 1 to 4 inclusive, and m, n, and p are 0, then at least one of X₁ and X₂ is S;
(b) if Z is O, W is CH₂, n is an integer from 1 to 4 inclusive, and m, p, and q are 0, then at least one of X₁ and X₂ is S; and,
(c) if Z is O and m, n, p, and q are 0, then at least one of X₁ and X₂ is S.

2. The monomer of claim 1, wherein the alkyl group or the aromatic group of R₃ or R₄ comprises at least one ring having 3, 4, 5, 6, 7, 8, or more members.

3. The monomer of claim 1, wherein the monomer is selected from Table I.

4. A polymerizable composition comprising at least two monomers, wherein at least one of the monomers corresponds to the compound of formula (I) of claim 1.

5. The polymerizable composition of claim 4, further comprising at least one initiator.

6. A polymer comprising at least one monomeric unit derived from the compound of formula (I) of claim 1.

7. An article comprising the polymer of claim 6.

8. The article of claim 7, wherein the article comprises at least one coating that comprises the polymer.

9. The article of claim 7, wherein the article is selected from the group consisting of: a dental restorative material, a lithographic material, a membrane, an adhesive, a printing plate, an ink, a holographic material, and a biomaterial.

10. A method of producing a polymer, the method comprising reacting at least two monomers with one another, wherein at least one of the monomers corresponds to a compound of formula (I): 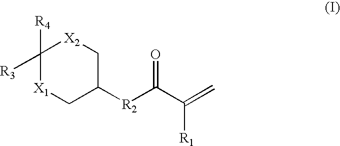
wherein
R₁ is CH₃ or H,
R₂ is (R₂ₐ)ₘWₙ(R_{2b})ₚY_{q}Z, wherein
R₂ₐ and R_{2b} are independently selected from carbonates, carbamates, ureas, dithiocarbonates, dithiocarbamates, thiocarbonates, thioureas, trithiocarbonates, and thiocarbamates,
m and p are independently selected from 0 and 1,
W is selected from CH₂ and (CH₂)ₜO,
Y is selected from CH₂ and (CH₂)ₙO,
t and s are integers independently selected from 0 to 50 inclusive,
n and q are integers independently selected from 0 to 50 inclusive,
Z is O or NH and is attached to the carbonyl moiety,
R₃ and R₄ are independently selected from H, a substituted or unsubstituted alkyl group, and a substituted or unsubstituted aromatic group, and
X₁ and X₂ are independently selected from O and S;
wherein
(a) if Z is O, Y is CH₂, q is an integer from 1 to 4 inclusive, and m, n, and p are 0, then at least one of X₁ and X₂ is S;
(b) if Z is 0, W is CH₂, n is an integer from 1 to 4 inclusive, and m, p, and q are 0, then at least one of X₁ and X₂ is S; and,
(c) if Z is O and m, n, p, and q are 0, then at least one of X₁ and X₂ is S.

11. The method of claim 10, wherein the reacting step comprises one or more of: irradiating a composition comprising the monomers, heating a composition comprising the monomers, or adding at least one catalyst to a composition comprising the monomers.

12. The method of claim 10, wherein the monomers react with one another to substantially quantitative double bond conversion.

13. The method of claim 10, wherein a composition comprises the monomers, which composition further comprises at least one initiator.

14. The polymer produced by the method of claim 10.

15. The method of claim 10, wherein at least one of the monomers is selected from Table I.
